(19) United States
(12) Patent Application Publication
(10) Pub. No.: US 2022/0230054 A1
(43) Pub. Date: Jul. 21, 2022

(54) OPERATION OF TRAINABLE MODULES, INCLUDING MONITORING AS TO WHETHER THE RANGE OF APPLICATION OF THE TRAINING IS ABANDONED

(71) Applicant: Robert Bosch GmbH, Stuttgart (DE)

(72) Inventors: Jan Mathias Koehler, Stuttgart (DE); Maximilian Autenrieth, Eislingen/Fils (DE); William Harris Beluch, Stuttgart (DE)

(21) Appl. No.: 17/611,088

(22) PCT Filed: Jun. 10, 2020
(86) PCT No.: PCT/EP2020/066022

§ 371 Date: Nov. 12, 2021

(30) Foreign Application Priority Data
Jun. 26, 2019 (DE) 10 2019 209 227.6

(51) Int. Cl. G06N 3/04; G06N 3/08; G06N 7/00

(52) U.S. Cl. CPC G06N 3/0454; G06N 7/005; G06N 3/082

(57) ABSTRACT

A method for operating a trainable module. At least one input variable value is supplied to variations of the trainable module, the variations differing so much from each other, that they may not be converted into each other in a congruent manner, using progressive learning. A measure of the uncertainty of the output variable values is ascertained from the difference of the output variable values, into which the variations translate, in each instance, the input variable value. The uncertainty is compared to a distribution of uncertainties, which is ascertained for input variable learning values used during training of the trainable module and/or for further input variable test values, to which relationships learned during the training of the trainable module are applicable. The extent to which the relationships learned during the training of the trainable module are applicable to the input variable value, is evaluated from the result of the comparison.

### FIELD

The present invention relates to the operation of trainable modules, as are used, for example, for classification tasks and/or object recognition during at least partially automated driving.

### BACKGROUND INFORMATION

As a rule, the driving of a vehicle in road traffic by a human driver is trained, in that within the scope of his/her training, a student driver is confronted again and again by situations, using a particular canon. In each instance, the student driver must react to these situations, and through commentary or even intervention of the driving instructor, he/she receives feedback as to whether his/her reaction was correct or incorrect. This training, using a finite number of situations, is supposed to enable the student driver to master unknown situations, as well, while driving the vehicle independently.

In order to allow vehicles to participate in road traffic in a fully or partially automated manner, attempts are made to control them, using modules trainable in a highly similar manner. These modules receive, for example, sensor data from the surroundings of the vehicle as input variables and supply control signals as output variables, by which the operation of the vehicle is influenced, and/or supply precursor products, from which such control signals are formed. For example, a classification of objects in the surroundings of the vehicle may be such a precursor product.

### SUMMARY

In the scope of the present invention, a method for operating a trainable module has been developed. The trainable module translates one or more input variable values into one or more output variable values.

A trainable module is regarded, in particular, as a module, which embodies a parameterized function that includes adjustable parameters and has a high power to generalize. During the training of a trainable module, the parameters may be adapted, in particular, in such a manner, that in response to inputting input variable learning values into the module, the corresponding output variable learning values are reproduced as effectively as possible. The trainable module may contain, in particular, an artificial neural network (ANN), and/or it may be an ANN.

The input variable values include measurement data, which are obtained, using a physical measuring operation, and/or using a partial or complete simulation of such a measuring operation, and/or using partial or complete simulation of a technical system capable of being monitored by such a measuring operation. For example, the measurement data may include images or scans, which are recorded by monitoring the surroundings of a vehicle.

When a trainable module is trained for such an application, this training is carried out, in principle, with the aid of a limited number of learning situations, that is, using a limited quantity of learning data. During training, the trainable module learns relationships, which, due to the above-mentioned power of generalization, also have validity for many other situations, which are not the subject of the training.

If the trainable module is used, for example, to classify traffic signs, other road users, roadway boundaries, and other objects, then the training typically includes situations having a certain variability, which encompasses, for instance, the weather conditions, road conditions, times of year, and lighting conditions expected to occur during operation of the vehicle. In this context, in particular, relationships are learned, which generally enable the detection of traffic signs in images. Thus, for example, the traffic sign 129, which warns of an unsecured river bank, is found only rarely in the public road space, but is extremely important in the individual case, is also detected under lighting conditions or weather conditions, under which it was not sighted during training.

However, it is now recognized that this power of generalization also has limits, which may lead to critical situations, for instance, during operation of an at least partially automated vehicle.

If, for example, the training is carried out only with images from the European traffic space, and if the trainable module is then used in the U.S.A., U.S. traffic signs, which are not found in Europe, are possibly classified incorrectly. Thus, for instance, in the U.S.A., there are many traffic signs, which are made up of a yellow square, which is standing on a vertex and includes black text (e.g., “dead end”). For instance, such a traffic sign could be misclassified as the only traffic sign found in Europe, which includes a yellow square standing on a vertex. This is the traffic sign 306 “main road.” In this specific example, a result of the error could be that upon entering the dead-end street, an at least partially automated vehicle accelerates in the belief of having free passage.

However, even if the trainable module is used in exactly the traffic space, for which it has been trained, comparable situations may occur. Thus, the traffic sign 270 “environmental zone,” which has been seen in more and more cities since 2008, is optically markedly similar to the traffic sign 274.1 “30 km/h speed zone.” In exactly the same manner, it includes a red circle with the word “ZONE” beneath it, only that instead of “environmental,” “30” is in the circle. If the trainable module is not yet trained for the new traffic sign “environmental zone,” it could possible misclassify this as a “30 km/h speed zone.” Since in cities, the traffic sign “environmental zone” may absolutely be found on expressways, as well, on which speeds of 80 km/h or more are allowed, the error could result in sudden, sharp deceleration of the vehicle. This would come as a complete surprise to traffic following behind and could lead to a rear-end collision.

In accordance with an example embodiment of the present invention, in order to prevent such critical situations, the method provides for at least one input variable value to be supplied to variations of the trainable module. These variations differ at least so much from each other, that they may not be converted into each other in a congruent manner by progressive learning.

The variations may be formed, for example, by deactivating (“dropping out”), in each instance, different neurons in an artificial neural network (ANN), which is contained in the trainable module. Then, different subsets of all the neurons present are active in all of the variations.

Alternatively, or also in combination with this, e.g., parameters, which characterize the behavior of the trainable module, may be varied.

For example, different sets of parameters may be obtained by training an ANN, using different subsets of the learning data. Each such set of parameters then characterizes the behavior of a variation. However, variations may also be obtained, for example, by inputting the learning data into the ANN in a different order, and/or by initializing the parameters of the ANN with different random starting values.

For example, trained weightings on the connections between neurons of the ANN may also be varied as parameters, by multiplying them by a number drawn randomly from a specified statistical distribution.

A measure of the uncertainty of the output variable values is ascertained from the difference of the output variable values, into which the variations of one and the same input variable value translate.

In this context, the output variable values may be, for example, softmax scores, which indicate the probabilities of the learning data set's being classified in the possible classes.

An arbitrary statistical function or a combination of statistical functions may be used for ascertaining the uncertainty from a plurality of output variable values. Examples of such statistical functions include the variance, the standard deviation, the mean, the median, an appropriately selected quantile, the entropy, and the variation ratio.

The uncertainty is compared to a distribution of uncertainties. This distribution is ascertained for input variable learning values and/or for further input variable test values, to which the relationships learned during the training of the trainable module are applicable. The extent, to which the relationships learned during the training of the trainable module are applicable to the input variable value to be processed currently, that is, for example, applicable to the image from the surroundings of the vehicle to be classified currently, is evaluated from the result of this comparison.

Therefore, the assignment of an output variable value to an input variable value is put, as it were, on the “vibration bench,” using the variations of the trainable module. In this context, it is to be expected that the distribution of uncertainties for such input variable values, to which the relationships learned during the training are applicable, includes a concentration of high frequencies for lower values of the uncertainty. A higher uncertainty, which “steps out of line” in light of this distribution, may then be evaluated as a sign that the relationships learned during the training are just not applicable to the input variable value to be processed currently. In the examples mentioned above, this is to be expected, for instance, if the U.S. traffic sign “dead end” is classified by a classifier trained on European traffic signs, or if the traffic sign “environmental zone” is classified by a classifier trained prior to the introduction of this traffic sign. Consequently, the tendency of such classifiers to output simply the traffic sign, which comes closest optically to the current traffic sign to be processed currently, without consideration for the completely different semantic meaning in the traffic events, may be counteracted.

In addition, an uncertainty, which does not fit the distribution, may also indicate that the input variable value is an “adversarial example.” This is to be understood as input variable values, which are intentionally manipulated with the objective of provoking a misclassification by the trainable module. Thus, for example, traffic signs, which are accessible to anyone in the public space, may be manipulated by applying stickers and similar devices, such that instead of “stop,” a speed limit of 70 km/h is recognized.

In this connection, the terms “deviations” and “uncertainty” are not limited to the one-dimensional, univariate case, but include variables of arbitrary dimension. Thus, a plurality of uncertainty features may also be combined, for example, in order to obtain a multivariate uncertainty. Therefore, for example, in the classification of traffic signs, a difference regarding the type of traffic sign (for instance, a rule, prohibition, or danger sign) may form a first dimension of the uncertainty, while a difference in the semantic meaning with regard to the traffic events forms a second dimension. In particular, for example, a difference or uncertainty may be measured quantitatively according to how different the results produced by the different output variable values are for the specific, concrete application. In this regard, the difference between a “speed limit 30 km/h” sign and a “speed limit 80 km/h” sign may be less than that between “speed limit 30 km/h” and “stop.”

The comparison of the uncertainty to a distribution of uncertainties instead of, for example, to a threshold value rigidly “soldered” to the control unit, has the particular advantage that this distribution may be updated constantly during the operation of the trainable module. Therefore, the test as to whether the relationships learned during the training of the trainable module are applicable to a specific input variable value, may not only draw from the experiences learned during the training, but also from the experiences during later operation. In a certain manner, this is analogous to a human driver, who does not stop his/her learning with the acquisition of the driver's license, but also still becomes better in response to independent driving.

In one particularly advantageous refinement of the present invention, in response to the uncertainty's lying within a predefined quantile of the distribution, it is determined that the relationships learned during the training of the trainable module are applicable to the input variable value. This quantile may be, for example, the 95% quantile. Behind this, is the realization that for the input variable values, to which the learned relationships are applicable, the distribution of the uncertainties typically has a high frequency at small values of uncertainty.

In one particularly advantageous refinement of the present invention, in response to the uncertainty's lying outside of a predefined quantile of the distribution, it is determined that the relationships learned during the training of the trainable module are not applicable to the input variable value. This quantile may be, in particular, a quantile different from the one, on the basis of which it is decided that the learned relationships are applicable to the input variable value. It may be, for example, the 99% quantile. Thus, for example, there may also be input variable values, with regard to which a statistically significant assertion as to whether or not the learned relationships are applicable, is not possible.

If the decision as to what extent the relationships learned during the training are applicable to the input variable value, is linked to a quantile of the distribution in one of the described ways, this also has the advantage that in response to updating the distribution during continuous operation, this criterion is automatically updated, as well.

In one particularly advantageous, further refinement of the present invention, in response to the uncertainty being less than a specified fraction of the smallest uncertainties in the distribution or greater than a specified fraction of the largest uncertainties in the distribution, it is determined that the relationships learned during the training of the trainable module are not applicable to the input variable value. For example, uncertainties, which are less than the smallest 2.5% of the uncertainties in the distribution or greater than the largest 2.5% of the uncertainties in the distribution, are interpreted to mean that the learned relationships are not applicable. In this context, the specific fraction of the smallest and/or largest uncertainties in the distribution may even be compressed, for example, by summarizing statistics to form a threshold value of the uncertainty. For example, the threshold value may be set to the mean or median of the smallest and/or largest 2.5% of the uncertainties in the distribution.

As explained above, the trainable module may take the form of, in particular, a classfier and/or a regressor. These are the most important tasks for trainable modules in the context of the at least partially automated driving. Thus, for example, in the semantic segmentation of an image, by which at least a portion of the surroundings of a vehicle is recorded, each image pixel is classified according to the type of object, to which it belongs.

As explained above, in one further, particularly advantageous refinement of the present invention, in response to the determination that the relationships learned during the training of the trainable module are applicable to the input variable value, the distribution is updated in view of the input variable value. In this manner, the decision as to what extent the learned relationships are applicable to an input variable value to be processed specifically, becomes more and more accurate with time.

For this purpose, in particular, e.g., a set of variables, which are each a function of a sum formed over all of the input variable values and/or uncertainties contributing to the distribution, may be updated by adding a further summand. The updated distribution and/or a set of parameters, which characterizes this updated distribution, is ascertained from these variables. In this manner, it is particularly simple to update the distribution incrementally. Then, in particular, the full set of uncertainties and/or input variable values considered up to now do not have to be stored, but it is sufficient to update the sum.

For example, let xᵢ, i=1, . . . , n, be the n uncertainties of the output variable values ascertained up to now, for n input variable values considered up to now. Examples of sums, of which the updated distribution and/or its parameters may be a function, include
Σᵢ₌₁ⁿ ln xᵢ,
Σᵢ₌₁ⁿ(ln xᵢ)²,
Σᵢ₌₁ⁿxᵢ,
Σᵢ₌₁ⁿxᵢ²,
Σᵢ₋₁ⁿ1/xᵢ,
−Σᵢ₌₁ⁿxᵢ^{k} for a known k, as well as
Σᵢ₌₁ⁿ ln(1−xᵢ).

The updating of sums is particularly advantageous in a further refinement, in which parameters of the distribution are estimated, using the method of moments, and/or using the maximum likelihood method, and/or using Bayesian estimation. In the method of moments, statistical moments of the overall distribution are deduced from statistical moments of a random sample of the distribution. In the maximum likelihood method, the values of the parameters, according to which the uncertainties actually observed appear to be the most plausible, are selected as an estimate.

In a particularly advantageous manner, the distribution is modeled as a statistical distribution, using a parameterized estimate; the parameters of the estimate being able to be expressed exactly and/or approximately by the moments of the statistical distribution. The moments may then be expressed, in turn, by the above-mentioned sums.

For example, the beta distribution of a random variable X is characterized substantially by two parameters α and β. As the first moments of this distribution, the expected value E[X] and the variance σ²[X] may be expressed in the parameters α and β:

$$E [ X ] = \frac{α}{α + β} and$$

$${σ}^{2} [ X ] = \frac{α β}{{( α + β )}^{2} ( α + β + 1 )}$$

At the same time, empirical estimators x̅ for the expected value E[X] and v̅ for the variance σ²[X] are specified on the basis of the specific random sample including N samples xᵢ:

$$\overline{x} = 1 / N {\sum }_{i = 1}^{N} {x}_{i} and$$

$$\overline{v} = \frac{1}{N - 1} {\sum }_{i = 1}^{N} {( {x}_{i} - \overline{x} )}^{2} .$$

Based on the variance translation theorem, the variance may also be estimated as

σ²(X)=E(X²)−[E(X)]²

which, expressed in empirical samples x₁, means

$${\hat{σ}}^{2} = \frac{1}{N - 1} {\sum }_{i = 1}^{N} {( {x}_{i} - \overline{x} )}^{2} ≡ \frac{1}{N - 1} ( ( {\sum }_{i = 1}^{N} {x}_{i}^{2} ) - {N ( \overline{x} )}^{2} ) .$$

In connection with the above expressions for the expected value E[X] and the variance σ²[X] in α and β, the estimates of α and β are yielded, expressed in the estimators x̅ and v̅ of E[X] and σ²[X]:

$$\hat{α} = \overline{x} ( \frac{\overline{x} ( 1 - \overline{x} )}{\overline{v}} - 1 ) and$$

$$\hat{β} = ( 1 - \overline{x} ) ( \frac{\overline{x} ( 1 - \overline{x} )}{\overline{v}} - 1 ) ;$$

in each instance, it being assumed that v̅<x̅(1−x̅).

Thus, in order to update these parameters in response to the arrival of new samples, only updates of Σᵢ₌₁ⁿxᵢ and Σᵢ₌₁ⁿxᵢ² are needed, which may be carried out incrementally by adding new summands.

In the gamma distribution, which is characterized by two parameters k and θ, one may proceed in an analogous manner. Here, the first moments E[X] and σ²[X], expressed in the parameters k and θ, are given by

E[X]=kθ and

σ²[X]=kθ².

In connection with the above-mentioned empirical estimator x̅ of the expected value E[X] and v̅ of the variance σ²[X], equations for estimators of the parameters k and θ are derived in a manner analogous to the beta distribution:

\hat{k}=x̅²/v̅² and \hat{θ}=v̅²/x̅.

Thus, only updates of Σᵢ₌₁ⁿxᵢ and Σᵢ₌₁ⁿxᵢ² are needed, in turn, for the incremental update.

If the parameters k and θ for the gamma distribution are estimated by the maximum likelihood method instead, the standard deviation o may be estimated, using

$$\overline{v} = ln ( \frac{1}{N} {\sum }_{i = 1}^{N} {x}_{i} ) - \frac{1}{N} {\sum }_{i = 1}^{N} ln ( {x}_{i} ) .$$

From this, k may be determined approximately as

$$k \approx \frac{3 - \overline{v} + \sqrt{{( \overline{v} - 3 )}^{2} + 24 \overline{v}}}{12 \overline{v}} .$$

In turn, an estimate of θ follows from this:

$$\hat{θ} = \frac{1}{k N} {\sum }_{i = 1}^{N} {x}_{i} .$$

Thus, in this case, updates of Σᵢ₌₁ⁿxᵢ and Σᵢ₌₁ⁿ ln xᵢ are needed for the incremental update.

Consequently, in the case of many distributions, the method of moments and the maximum likelihood method are based on the sufficient statistics, which are simple to determine, above all, in distributions from the exponential family. Therefore, the distribution of uncertainties is modeled particularly advantageously as a distribution from the exponential family, such as the normal distribution, exponential distribution, gamma distribution, chi-squared distribution, beta distribution, exponential Weibull distribution, and/or Dirichlet distribution.

However, the parameters of the parameterized estimate of the distribution may also be ascertained, for example, according to a different likelihood method and/or according to a Bayesian method, such as, using the expectation-maximization algorithm, the expectation/conditional-maximization algorithm, the expectation-conjugate-gradient algorithm, a Newton-based method, a Markov chain Monte Carlo-based method, and/or a stochastic-gradient algorithm.

In a further, particularly advantageous refinement of the present invention, in response to the determination that the relationships learned during the training of the trainable module are applicable to the input variable value, a control signal is ascertained from an output variable value supplied for this input variable value, by the trainable module and/or its variations. A vehicle and/or a classification system and/or a system for the quality control of mass-produced products and/or a system for medical imaging, is controlled by this control signal. In this manner, such technical systems may be protected from negative effects, which may result when an output variable value completely inappropriate for the specific application is generated for an input variable value lying outside of the “qualification” acquired by training the trainable module.

In one further advantageous refinement of the present invention, in response to the relationships' learned during the training of the trainable module not being applicable to the input variable value, countermeasures are taken, in order to prevent a negative effect, on a technical system, of an output variable value supplied for this input variable value by the trainable module and/or its variations. As explained above, the criterion for this may be stricter (for instance, “on the other side of the 99% quantile of the distribution”) than the criterion for the learned relationships' being applicable (for instance, “within the 95% quantile”). Thus, there may be input variable values, for which none of the two conditions are true, and these input value variables may optionally be discarded, for example, or used for generating a control signal, as well, possibly connected to a warning that the technical system is steering towards a threshold range.

The possible countermeasures for the case, in which the learned relationships are not applicable, are varied and may be taken individually or in combination, for example, in a hierarchy of escalating steps. For example,
the output variable value may be suppressed; and/or
a correction and/or a substitute for the output variable value may be ascertained; and/or
an output variable learning value belonging to the input variable value may be requested for the further training of the trainable module (“subsequent labeling”); and/or
updating for the trainable module may be requested; and/or
a technical system controlled, using the trainable module, may be restricted in its functionality or may be stopped; and/or
a further sensor signal may be requested from another sensor.

For example, in an at least partially automated vehicle, the ride comfort may be increasingly reduced in a progressive manner, for instance, by changing the operating dynamics, or by switching off comfort functions, such as the heating or air conditioning, in order to force an update of the trainable module due after a change in the traffic sign catalog. As a final consequence, for instance, after a grace period defined in time or kilometers, the automated driving function may be deactivated completely.

In the area of medical imaging, in particular, the request for subsequent labeling is useful as a countermeasure. For example, with the aid of images of a human eye, the trainable module may be trained to ascertain the severity of diabetic retinopathy by classification or regression. If, alternatively or additionally to diabetic retinopathy, a recorded image now indicates a cataract, this may then be diagnosed by a human expert, who is responsible for the subsequent labeling.

In an analogous manner, for example, in a system for quality control, a new error profile may suddenly appear next to the errors, for the detection of which the trainable module has been trained. Due to the recognition that the relationships learned during the training of the trainable module are suddenly no longer applicable to the measurements taken (for instance, using visible light, infrared or ultrasound), attention may be directed to the new error profile for the first time.

A sensor signal requested from a further sensor may be used, for example, in order to correct and/or replace the output variable value directly. However, it may also be used, for example, to correct and/or replace the input variable value and, in this way, to acquire an output variable value more accurate for the application. For example, an input variable value ascertained from an optical image or video may be modified, using additional information from a radar and/or lidar recording of the same scenery.

A correction of and/or replacement for the output variable value may be requested, for example, from a separate ANN, which may be designed, in particular, specifically to be more robust with respect to outliers and other special cases, for example. This separate ANN may live, for example, in a cloud, so that more computing power is available for its inference than on board a vehicle.

The trainable module may be configured, in particular, for use of the method described above, in that on the basis of input variable learning values utilized during the training, a distribution of the respectively resulting uncertainties of the output variable values is ascertained.

Thus, the present invention also relates to a method for training a trainable module. The training takes place, using learning data sets, which include input variable learning values and corresponding output variable learning values. Input variable learning values (some, many, or even all from the total set available) are supplied to the variations of the trainable module in the described manner, and the uncertainty of the output variable learning values generated for each individual input variable learning value is ascertained in the described manner. A distribution of the uncertainties is then ascertained over the input variable learning values utilized in this manner.

The variations may be derived, in particular, in the same manner as for the method of operation described above.

The methods may be implemented, in particular, completely or partially, in the form of software. Thus, the present invention also relates to a computer program including machine-readable instructions, which, when they are executed on one or more computers, cause the computer(s) to carry out one of the described methods. A download product is a digital product, which is transmittable over a data network, that is, is downloadable by a user of the data network, and may, for example, be offered for sale in an online shop for immediate downloading.

In addition, a computer may be supplied with the computer program, with the machine-readable storage medium, and/or with the download product.

Further measures improving the present invention are represented below in more detail, in light of figures, together with the description of the preferred exemplary embodiments of the present invention.

### BRIEF DESCRIPTION OF THE DRAWINGS

FIG. 1 shows an exemplary embodiment of method 100 for operating a trainable module 1, in accordance with the present invention.

FIG. 2 shows an exemplary embodiment of method 200 for training a trainable module 1, in accordance with the present invention.

FIG. 3 shows examples of distributions 13* of the density of uncertainties 13b, in light of which it may be discerned that the relationships learned by the trainable module are no longer applicable to certain input variable values.

FIG. 4 shows an explanation of the incremental update of distribution 13* during the operation of trainable module 1.

### DETAILED DESCRIPTION OF EXAMPLE EMBODIMENTS

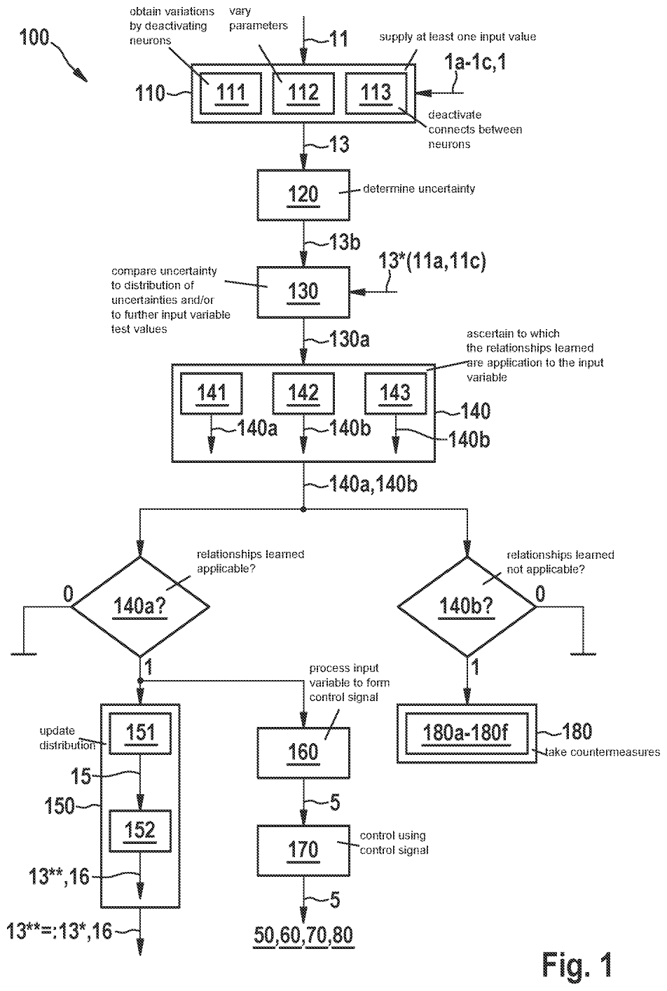

FIG. 1 shows a flow chart of an exemplary embodiment of method 100. In step 110, at least one input variable value 11, which is to be processed currently by trainable module 1, is supplied to a plurality of variations 1a-1c of trainable module 1.

In this context, according to block 111, the variations may be obtained by deactivating different neurons of an ANN via “dropping-out.” Alternatively, or in combination with this, according to block 112, parameters, which characterize the behavior of trainable module 1, are varied. In addition, as an alternative to this or in combination with this, according to block 113, connections between neurons in the ANN may be deactivated.

The different variations 1a-1c of trainable module 1 generate different output variable values 13 from one and the same input variable value 11. In step 120, an uncertainty 13b is determined from these output variable values 13. In step 130, this uncertainty 13b is compared to a distribution 13* of uncertainties 13b, which are applicable to input variable learning values 11a used during the training of trainable module 1 and/or to further input variable test values 11c, which are applicable to the relationships learned during the training. In step 140, the extent, to which the relationships learned during the training of trainable module 1 are applicable to the input variable value 11 that is supplied at the outset and is to be processed specifically by trainable module 1, is ascertained from result 130a.

According to block 141, e.g., in response to uncertainty 13b lying within a predefined quantile of distribution 13*, it is determined 140a that the relationships learned during the training of trainable module 1 are applicable to input variable value 11.

According to block 142, e.g., in response to uncertainty 13b lying outside of a predefined quantile of distribution 13*, it is determined 140b that the relationships learned during the training of trainable module 1 are not applicable to input variable value 11.

According to block 143, in response to uncertainty 13b being less than a specified fraction of the smallest uncertainties 13b in distribution 13* or greater than a specified fraction of the largest uncertainties 13b in distribution 13*, it is determined 140b that the relationships learned during the training of trainable module 1 are not applicable to input variable value 11.

On the basis of determinations 140a, 140b possibly made in step 140, different measures, which are represented illustratively in FIG. 1, may now be taken.

In response to the determination 140a that the relationships learned during the training of trainable module 1 are applicable to input variable value 11, in step 150, distribution 13* may be updated, using this input variable value 11.

For this purpose, e.g., according to block 151, a set of variables 15, which are each a function of a sum formed over all of the input variable values 11 and/or uncertainties 13b contributing to distribution 13*, may be updated by adding a further summand. The updated distribution 13** and/or a set of parameters 16, which characterizes this updated distribution 13**, is ascertained from these variables 15. Updated distribution 13** may be used subsequently as new distribution 13*.

In addition, in response to determination 140a, in step 160, input variable value 11 may be processed by trainable module 1 and/or by one or more of variations 1a-1c, to form a control signal 5. In step 170, a vehicle 50 and/or a classification system 60 and/or a system 70 for the quality control of mass-produced products and/or a system 80 for medical imaging, may then be controlled by this control signal 5.

However, if the determination 140b is made that the relationships learned during the training of trainable module 1 are not applicable to input value variable 11, then countermeasures 180 may be taken, in order to prevent a disadvantageous effect on a technical system 50, 60, 70, 80, of an inapplicable output variable value possibly ascertained on the basis of such an input variable value 11. For example,
according to option 180a, the output variable value may be suppressed; and/or
according to option 180b, a correction and/or a substitute for the output variable value may be ascertained; and/or
according to option 180c, an output variable learning value belonging to the input variable value may be requested for the further training of the trainable module (“subsequent labeling”); and/or
according to option 180d, updating for the trainable module may be requested; and/or
according to option 180e, a technical system controlled, using the trainable module, may be restricted in its functionality or may be stopped; and/or
according to option 180f, a further sensor signal from another sensor may be requested.

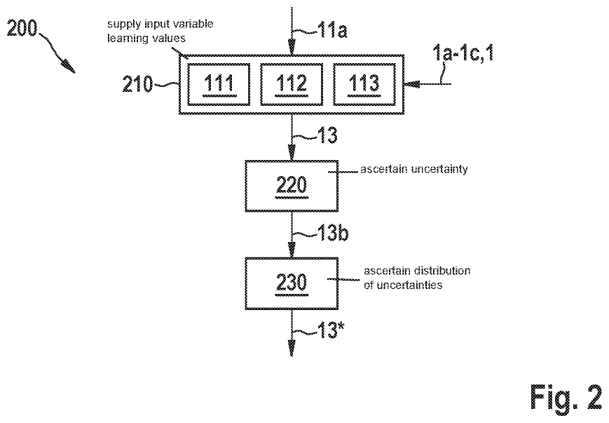

FIG. 2 shows a flow chart of an exemplary embodiment of method 200 for training a trainable module 1. In step 210, input variable learning values 11a, which are used for the training, are supplied to variations 1a-1c of trainable module 1, which may be formed, for example, in the same manner as described in connection with FIG. 1 (blocks 111 to 113). As described in connection with FIG. 1, in this case, a plurality of output variable values 13 are obtained for one and the same input variable learning value 11a, so that in step 220, uncertainty 13b may be ascertained from the alternate variations. In step 230, a distribution 13* of uncertainties 13b over the utilized input variable learning values 11a is ascertained.

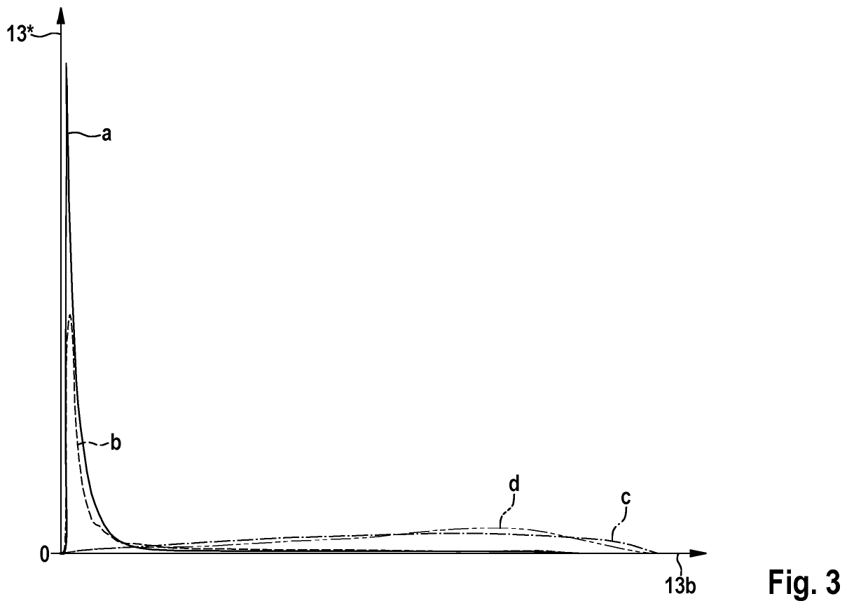

FIG. 3 clarifies the basic principle of the above-described method with the aid of illustrative, actual distributions of uncertainties. By way of example, a trainable module 1 is trained to process the images of handwritten numerals contained in the MNIST data set as input variable values 11 and, to this end, to supply, in each instance, the numeral from 0 to 9, which represents the image, as output variable value 13. After completion of the training, a distribution 13* of uncertainties 13b, which are produced with regard to the output variables 13 ascertained from the different variations 1a-1c, is ascertained for the input variable test values 13c, which are separate from input variable learning values 11a and are likewise images including handwritten numerals.

Curve a in FIG. 3 shows a beta distribution 13* fitted to uncertainties 13b. Curve b shows, as distribution 13*, a kernel density estimator fitted to the same uncertainties 13b. What these two distributions 13* have in common, is that low uncertainties occur in very high frequencies, and consequently, for example, the 95% quantile is situated comparatively low on the scale of uncertainty 13b.

Curve c shows a beta distribution 13*, and curve d shows a kernel density estimator as a distribution 13* for an extreme situation, in which the input variable test values used for the determination of uncertainties 13b have nothing at all to do with the application, for which trainable module 1 is trained. Specifically used, were images from the MNIST fashion data set, which show the clothing, shoes and accessories from the product line of the shipper Zalando. Distributions 13* are spread over a wide range and are quite flat. Significant frequencies of uncertainties 13b first occur at higher values of uncertainties 13b, at which the distributions 13* ascertained on the basis of input learning data 11a already do not exhibit any more significant frequencies of uncertainties 13b.

Thus, for the case in which trainable module 1 is trained for images of handwritten numerals and is suddenly confronted with an image of a garment, the above-described method produces a highly clear signal that the relationships concerning handwritten numerals learned by the trainable module in the course of its training are not applicable to images of clothes.

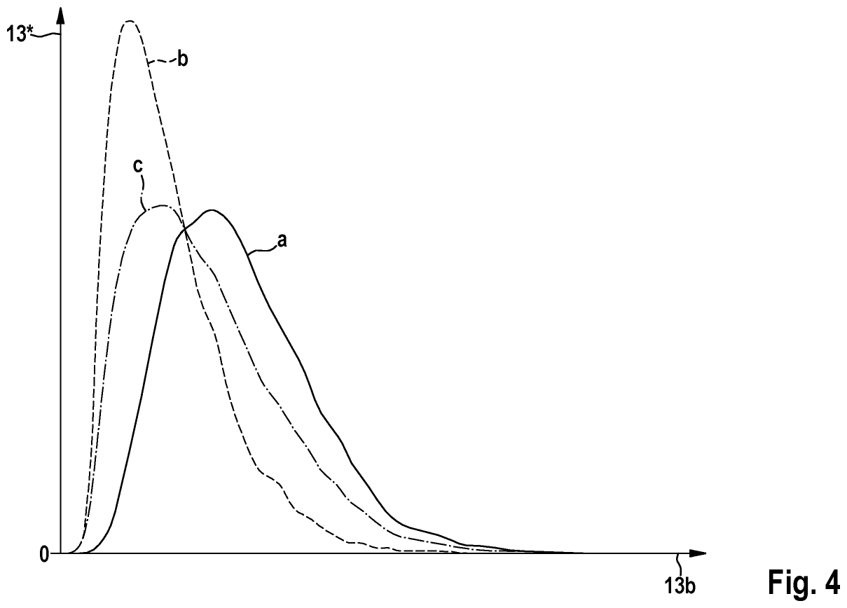

FIG. 4 clarifies the constant updating of distribution 13* during the operation of trainable module 1. Curve a shows a distribution 13* of uncertainties 13b, which is ascertained on the basis of the input variable learning values 11a of trainable module 1. This corresponds to an illustrative state, in which trainable module 1 may be delivered to an end customer. Curve b shows an example of a distribution 13* of uncertainties 13b, which may be produced with regard to further input variable test values 11c occurring during operation of trainable module 1. This distribution 13* is highly concentrated towards smaller uncertainties 13b, which means that these input variable test values 11c effectively match the application, for which trainable module 1 was trained. If, in the moment, in which they were identified as fitting the relationships learned by the trainable module (determination 140a), these input variable test values 11c are each used for the incremental updating of the distribution 13* utilized for the test of input variable values 11 presented in the future, then this distribution 13* may change, for example, from curve a to curve c.

1-19. (canceled)

20. A method for operating a trainable module, which translates one or more input variable values into one or more output variable values, the input variable values including measurement data, which are obtained by a physical measuring operation and/or by a partial or complete simulation of the measuring operation and/or by a partial or complete simulation of a technical system capable of being monitored by the measuring operation, the method comprising the following steps:
supplying at least one input variable value to variations of the trainable module, the variations differing so much from each other, that they may not be converted into each other in a congruent manner, using progressive learning;
ascertaining a measure of uncertainty of output variable values from a difference of the output variable values, into which each of the variations translate the input variable value;
comparing the uncertainty to a distribution of uncertainties, which is ascertained for input variable learning values used during training of the trainable module and/or for further input variable test values, to which relationships learned during the training of the trainable module are applicable; and
evaluating the extent to which the relationships learned during the training of the trainable module are applicable to the input variable value, based on a result of the comparison.

21. The method as recited in claim 20, wherein the variations are formed:
by deactivating different neurons in an artificial neural network (ANN) which is contained in the trainable module; and/or
by varying parameters which characterize a behavior of the trainable module; and/or
by deactivating connections between neurons in the ANN.

22. The method as recited in claim 20, further comprising:
in response to the uncertainty lying within a specified quantile of the distribution, determining that the relationships learned during the training of the trainable module are applicable to the input variable value.

23. The method as recited in claim 20, further comprising:
in response to the uncertainty lying outside of a specified quantile of the distribution, determining that the relationships learned during the training of the trainable module are not applicable to the input variable value.

24. The method as recited in claim 20, further comprising:
in response to the uncertainty being less than a specified fraction of smallest uncertainties in the distribution or greater than a specified fraction of largest uncertainties in the distribution, determining that the relationships learned during the training of the trainable module are not applicable to the input variable value.

25. The method as recited in claim 20, wherein the trainable module is a classifier and/or a regressor.

26. The method as recited in claim 20, further comprising:
in response to a determination that the relationships learned during the training of the trainable module are applicable to the input variable value, updating the distribution using the input variable value.

27. The method as recited in claim 26, wherein:
a set of variables, which are each a function of a sum formed over all input variable values and/or uncertainties contributing to the distribution, is updated by adding a further summand; and
the updated distribution and/or a set of parameters which characterizes the updated distribution, is ascertained from the set of variables.

28. The method as recited in claim 27, wherein the parameters are estimated, using a method of moments, and/or using a maximum likelihood method, and/or using a Bayesian estimation.

29. The method as recited in claim 20, further comprising:
in response to a determination that the relationships learned during the training of the trainable module are applicable to the input variable value:
ascertaining a control signal from an output variable value supplied for the input variable value, by the trainable module and/or the variations; and
controlling, using the control signal, a vehicle and/or a classification system and/or a system for quality control of mass-produced products and/or a system for medical imaging.

30. The method as recited in claim 20, further comprising:
in response to a determination that the relationships learned during the training of the trainable module are not applicable to the input variable value, taking countermeasures, in order prevent a negative effect, on a technical system, of an output variable value supplied for the input variable value by the trainable module and/or by the variations.

31. The method as recited in claim 30, wherein the countermeasures include:
suppressing the output variable value; and/or
ascertaining a correction and/or a substitute for the output variable value; and/or
requesting an output variable learning value belonging to the input variable value for a further training of the trainable module; and/or
requesting an updating for the trainable module; and/or
restricting a technical system controlled using the trainable module, in its functionality or stopping the technical system; and/or
requesting a further sensor signal from another sensor.

32. A method for training a trainable module, which translates one or more input variable values into one or more output variable values, using learning data sets which contain input variable learning values and corresponding output variable learning values, at least the input variable learning values including measurement data, which are obtained by a physical measuring operation and/or by a partial or complete simulation of the measuring operation and/or by a partial or complete simulation of a technical system capable of being monitored by the measuring operation, the method comprising the following steps:
supplying input variable learning values to variations of the trainable module, the variations differing so much from each other that they may not be converted into each other in a congruent manner, using progressive learning;
ascertaining a measure of the uncertainty of output variable values from a difference of the output variable values, from each other, into which each of the variations translate, the same input variable learning value;
ascertaining a distribution of the uncertainties.

33. The method as recited in claim 32, wherein the distribution is modeled as a statistical distribution, using a parameterized estimate, and parameters of the estimate being expressed by moments of the statistical distribution.

34. The method as recited in claim 33, wherein the parameters of the estimate are ascertained according to a likelihood method and/or according to a Bayesian method.

35. The method as recited in claim 33, wherein the parameters of the estimate are ascertained using an expectation-maximization algorithm, and/or an expectation/conditional-maximization algorithm, and/or an expectation-conjugate-gradient algorithm, and/or a Newton-based method, and/or a Markov chain Monte Carlo-based method, and/or a stochastic-gradient algorithm.

36. The method as recited in claim 32, wherein the distribution is modeled as a distribution an exponential family.

37. The method as recited in claim 32, wherein the distribution is modeled as a normal distribution, and/or an exponential distribution, and/or a gamma distribution, and/or a chi-squared distribution, and/or a beta distribution, and/or an exponential Weibull distribution, and/or a Dirichlet distribution.

38. A non-transitory machine-readable storage medium on which are stored a computer program including machine-readable instructions for operating a trainable module, which translates one or more input variable values into one or more output variable values, the input variable values including measurement data, which are obtained by a physical measuring operation and/or by a partial or complete simulation of the measuring operation and/or by a partial or complete simulation of a technical system capable of being monitored by the measuring operation, the machine-readable instructions, when executed by one or more computers, causing the one or more computer to perform the following steps:
supplying at least one input variable value to variations of the trainable module, the variations differing so much from each other, that they may not be converted into each other in a congruent manner, using progressive learning;
ascertaining a measure of uncertainty of output variable values from a difference of the output variable values, into which each of the variations translate the input variable value;
comparing the uncertainty to a distribution of uncertainties, which is ascertained for input variable learning values used during training of the trainable module and/or for further input variable test values, to which relationships learned during the training of the trainable module are applicable; and
evaluating the extent to which the relationships learned during the training of the trainable module are applicable to the input variable value, based on a result of the comparison.

39. A computer configured to operate a trainable module, which translates one or more input variable values into one or more output variable values, the input variable values including measurement data, which are obtained by a physical measuring operation and/or by a partial or complete simulation of the measuring operation and/or by a partial or complete simulation of a technical system capable of being monitored by the measuring operation, the computer configured to:
supply at least one input variable value to variations of the trainable module, the variations differing so much from each other, that they may not be converted into each other in a congruent manner, using progressive learning;
ascertain a measure of uncertainty of output variable values from a difference of the output variable values, into which each of the variations translate the input variable value;
compare the uncertainty to a distribution of uncertainties, which is ascertained for input variable learning values used during training of the trainable module and/or for further input variable test values, to which relationships learned during the training of the trainable module are applicable; and
evaluate the extent to which the relationships learned during the training of the trainable module are applicable to the input variable value, based on a result of the comparison.
